(19) United States
(12) Patent Application Publication
(10) Pub. No.: US 2025/0293330 A1
(43) Pub. Date: Sep. 18, 2025

(54) POWER STORAGE DEVICE AND VEHICLE

(71) Applicants: TOYOTA JIDOSHA KABUSHIKI KAISHA, Aichi-ken (JP); TOYOTA BATTERY CO., LTD., Shizuoka (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Yuji KATAYAMA, Okazaki-shi (JP); Masaya OGURA, Hamamatsu-shi (JP); Ryutaro SUZUKI, Hamamatsu-shi (JP)

(21) Appl. No.: 19/066,152

(22) Filed: Feb. 28, 2025

(30) Foreign Application Priority Data
Mar. 13, 2024 (JP) 2024-039258

(51) Int. Cl. H01M 10/54; H01M 10/42; H01M 50/30; H01M 50/474

(52) U.S. Cl. CPC H01M 10/54; H01M 10/4257; H01M 50/30; H01M 50/474; H01M 2220/20

(57) ABSTRACT

A power storage device includes a first cell connected body and a second cell connected body electrically connected to each other. The first cell connected body includes a plurality of first power storage cells and a first connection portion that electrically connects the first power storage cells to each other. The second cell connected body includes a plurality of second power storage cells and a second connection portion that electrically connects the second power storage cells to each other. The power storage device further includes a holding member that holds the first power storage cell and the second power storage cell that are opposed to each other. At least a portion of the holding member is located between the first power storage cell and the second power storage cell that are opposed to each other.

### CROSS REFERENCE TO RELATED APPLICATIONS

This nonprovisional application is based on Japanese Patent Application No. 2024-039258 filed with the Japan Patent Office on Mar. 13, 2024, the entire contents of which are hereby incorporated by reference.

### BACKGROUND

### Field

The present disclosure relates to a power storage device and a vehicle including the power storage device.

### Description of the Background Art

Japanese National Patent Publication No. 2023-502457 discloses a battery (power storage device) in a shape of a parallelepiped having a length L from 400 mm to 2500 mm and having a ratio (L/H) of length L to a width H of 4 to 21.

### SUMMARY

In the power storage device described in Japanese National Patent Publication No. 2023-502457, a plurality of electrode core sets aligned in a line as being connected in series are arranged in a casing (housing). In this power storage device, an electrode core set corresponds to a power storage cell. A connected body where a plurality of power storage cells are connected in a line is referred to as a “cell connected body” below.

In order to improve a volumetric energy density of a power storage device, advantageously, not only a single cell connected body but also a plurality of cell connected bodies are accommodated in a casing. Excessive movement of the plurality of cell connected bodies in the casing, however, tends to cause damage to a portion of connection between the cell connected bodies or a portion of connection between power storage cells. Each cell connected body may be fixed to an inner surface of the casing with an adhesive high in adhesiveness. In connection with the power storage device where such a fixing method is adopted, however, in disassembly of the used power storage device and re-use of a component, it is difficult to separate the casing and each cell connected body from each other. Therefore, there is a room for improvement in recyclability of the power storage device including the plurality of cell connected bodies.

The present disclosure was made to solve the problem above, and an object thereof is to improve recyclability of a power storage device including a plurality of cell connected bodies.

According to a form according to a first point of view of the present disclosure, a power storage device shown below is provided.

(Clause 1) A power storage device includes a first cell connected body and a second cell connected body electrically connected to each other. The first cell connected body includes a plurality of first power storage cells and a first connection portion that electrically connects the first power storage cells to each other. The second cell connected body includes a plurality of second power storage cells and a second connection portion that electrically connects the second power storage cells to each other. At least one of the plurality of first power storage cells is arranged as being opposed in a first direction to any of the plurality of second power storage cells. The power storage device further includes a holding member that holds the first power storage cell and the second power storage cell that are opposed to each other. At least a portion of the holding member is located between the first power storage cell and the second power storage cell that are opposed to each other.

According to the construction, by being held by the holding member, the first power storage cell and the second power storage cell are less likely to move. Therefore, an adhesive for fixing the first cell connected body and the second cell connected body does not have to be used, or adhesiveness of an adhesive to be used can be weak. Recyclability of the power storage device is thus improved. In each of the first cell connected body and the second cell connected body, each connection portion may be made from a conductive member. Each connection portion may connect electrodes of adjacent power storage cells to each other. As the electrode of the first cell connected body and the electrode of the second cell connected body are connected to each other (for example, those electrodes come in contact with each other or those electrodes are connected to each other through the conductive member), the first cell connected body and the second cell connected body may electrically be connected to each other. A positive electrode of the first cell connected body and a negative electrode of the second cell connected body may be connected to each other. The positive electrode of the first cell connected body and a positive electrode of the second cell connected body may be connected to each other. The first cell connected body and the second cell connected body may be connected in series or in parallel.

(Clause 2) In the power storage device described in Clause 1, the holding member includes a main body portion located between the first power storage cell and the second power storage cell, a first cell holding portion that extends from the main body portion toward the first power storage cell and holds the first power storage cell, and a second cell holding portion that extends from the main body portion toward the second power storage cell and holds the second power storage cell.

According to the holding member, the first power storage cell and the second power storage cell are more readily appropriately held.

(Clause 3) In the power storage device described in Clause 2, the main body portion is located between the first power storage cell and the second power storage cell in the first direction. The first cell holding portion clamps the first power storage cell. The second cell holding portion clamps the second power storage cell.

The holding member can properly restrict movement of each of the first power storage cell and the second power storage cell by clamping each power storage cell.

(Clause 4) In the power storage device described in any one of Clauses 1 to 3, the plurality of first power storage cells in the first cell connected body are aligned in a second direction orthogonal to the first direction. The plurality of second power storage cells in the second cell connected body are aligned in the second direction. The holding member has a cross-section in an X shape as a cross-section orthogonal to the second direction.

According to the holding member, even when a gap between the first and second power storage cells is narrow, the first power storage cell and the second power storage cell are more readily appropriately held.

(Clause 5) In the power storage device described in any one of Clauses 1 to 4, the holding member includes a first resin member that holds the first power storage cell, a second resin member that holds the second power storage cell, and a metallic plate located between the first resin member and the second resin member.

While the holding member appropriately holds each power storage cell with the resin member, it can achieve enhanced thermal conductivity between each power storage cell and the surroundings thereof owing to the metallic plate. For example, heat from each power storage cell tends to be radiated through the metallic plate. In heating each power storage cell, heat tends to conduct to each power storage cell through the metallic plate.

(Clause 6) The power storage device described in any one of Clauses 1 to 5 further includes a circuit board that senses smoke. The holding member is provided with a flow path that guides smoke emitted from at least one of the first power storage cell and the second power storage cell opposed to each other to the circuit board.

According to the construction, smoke emitted from at least one of the first power storage cell and the second power storage cell held by the holding member is more readily sensed.

(Clause 7) The power storage device described in any one of Clauses 1 to 6 further includes a circuit board that senses smoke and a spacer located between power storage cells adjacent in the first cell connected body and/or between power storage cells adjacent in the second cell connected body. The spacer is provided with a flow path that guides smoke emitted from at least one of the adjacent power storage cells to the circuit board.

According to the construction, smoke emitted from at least one of two power storage cells adjacent with the spacer being interposed is more readily sensed.

(Clause 8) In the power storage device described in any one of Clauses 1 to 7, each of the plurality of first power storage cells is arranged as being opposed in the first direction to any of the plurality of second power storage cells. The holding member is provided for each combination of the first power storage cell and the second power storage cell opposed to each other.

According to the construction, all first power storage cells included in the first cell connected body can be held by the holding member.

According to a form according to a second point of view of the present disclosure, a vehicle shown below is provided.

(Clause 9) The vehicle includes the power storage device according to any one of Clauses 1 to 8.

In connection with the vehicle, recyclability of the power storage device including the plurality of cell connected bodies is improved.

The foregoing and other objects, features, aspects, and advantages of this disclosure will become more apparent from the following detailed description of this disclosure when taken in conjunction with the accompanying drawings.

### BRIEF DESCRIPTION OF THE DRAWINGS

FIG. 1 is a diagram for illustrating a construction of a power storage device according to an embodiment of the present disclosure.

FIG. 2 is a perspective view showing as being enlarged, inside of a casing of the power storage device shown in FIG. 1.

FIG. 3 is a diagram for illustrating a construction of each cell connected body shown in FIG. 1.

FIG. 4 is an exploded perspective view of a power storage cell included in each cell connected body shown in FIG. 1.

FIG. 5 is a cross-sectional view along the line V-V in FIG. 1.

FIG. 6 is a cross-sectional view along the line VI-VI in FIG. 1.

FIG. 7 is a diagram showing a first modification of the power storage device shown in FIG. 1.

FIG. 8 is a cross-sectional view along the line VIII-VIII in FIG. 7.

FIG. 9 is a diagram showing a modification of a structure of a holding member shown in FIG. 5.

FIG. 10 is a diagram showing a modification of the holding member shown in FIG. 9.

FIG. 11 is a diagram showing a second modification of the power storage device shown in FIG. 1.

FIG. 12 is a cross-sectional view along the line XII-XII in FIG. 11.

FIG. 13 is a diagram showing a third modification of the power storage device shown in FIG. 1.

FIG. 14 is a cross-sectional view along the line XIV-XIV in FIG. 13.

FIG. 15 is a diagram showing a fourth modification of the power storage device shown in FIG. 1.

FIG. 16 is a cross-sectional view along the line XVI-XVI in FIG. 15.

FIG. 17 is a cross-sectional view along the line XVII-XVII in FIG. 15.

FIG. 18 is a diagram showing an example in which a flow path is provided in a spacer shown in FIG. 6.

FIG. 19 is a diagram showing an example in which a flow path is provided in the holding member shown in FIG. 10.

FIG. 20 is a diagram showing an exemplary power storage module made by combining a plurality of batteries shown in FIG. 1.

FIG. 21 is a diagram showing an exemplary vehicle on which the power storage module shown in FIG. 20 is mounted.

### DESCRIPTION OF THE PREFERRED EMBODIMENTS

An embodiment of the present disclosure will be described in detail with reference to the drawings. The same or corresponding elements in the drawings have the same reference characters allotted and description thereof will not be repeated. In each figure referred to below, among an X axis, a Y axis, and a Z axis orthogonal to one another, the X axis represents a first in-plane direction (for example, a length direction) of a battery, the Y axis represents a second in-plane direction (for example, a width direction) of the battery, and the Z axis represents a height direction of the battery. A direction indicated by an arrow along each of the X axis, the Y axis, and the Z axis is expressed with “+” below, and a direction opposite thereto is expressed with “−”.

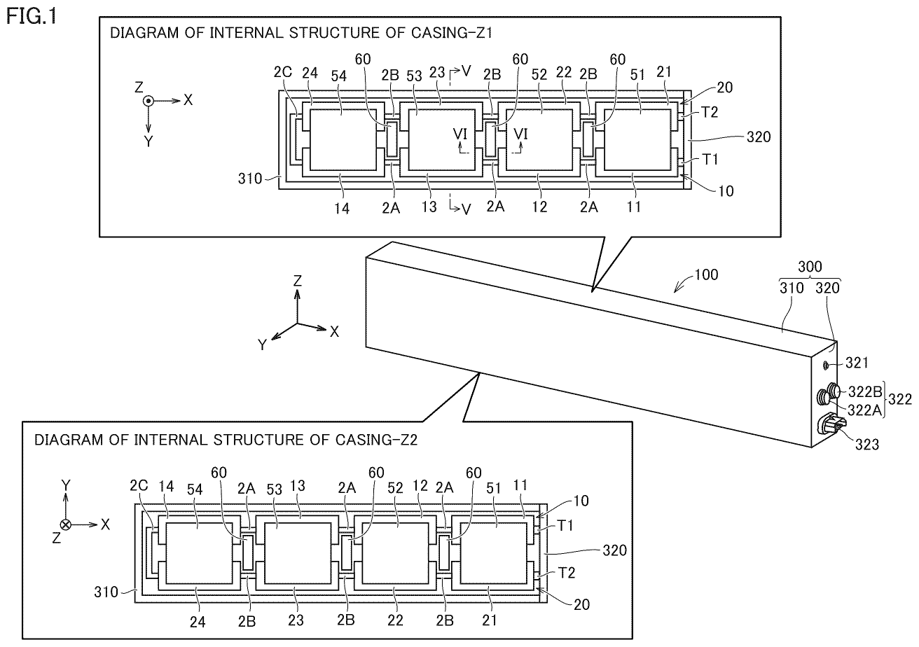

FIG. 1 is a diagram for illustrating a construction of a power storage device according to this embodiment. A “diagram of internal structure of casing-Z1” in FIG. 1 is a diagram of components in the casing viewed from a +Z side. A “diagram of internal structure of casing-Z2” is a diagram of components in the casing viewed from a −Z side.

The power storage device according to this embodiment is a battery 100 shown in FIG. 1. Battery 100 is a secondary battery such as a lithium ion battery, a nickel metal hydride battery, or a sodium ion battery. An exemplary lithium ion battery includes an LFP battery in which lithium iron phosphate is adopted as a positive electrode active material or a ternary battery in which nickel manganese cobalt (NMC) is adopted as the positive electrode active material. A type of the secondary battery may be a liquid secondary battery or an all-solid secondary battery. Though details will be described later, battery 100 includes a plurality of power storage cells each of which functions as the secondary battery. Battery 100 may include only power storage cells of the same type (for example, only LFP batteries) or power storage cells different in type (for example, the LFP battery and the ternary battery).

Battery 100 includes a casing 300 in a shape of a parallelepiped. A length (a dimension in an X direction) of casing 300 is longer than a width (a dimension in a Y direction) of casing 300. The length of casing 300 may be not smaller than 250 mm and not larger than 5000 mm, and it is, for example, approximately 1000 mm. The width of casing 300 may be not smaller than 10 mm and not larger than 1250 mm, and it is, for example, approximately 50 mm. A ratio of the length of casing 300 to the width of casing 300 may be not lower than 4 and not higher than 25. A height (a dimension in a Z direction) of casing 300 may be not smaller than 10 mm and not larger than 1250 mm, and it is, for example, approximately 100 mm. The dimension of casing 300 is not limited as above.

Casing 300 includes a main body 310 and a lid body 320. Main body 310 is a hollow housing with bottom, for example, provided with an opening in an end surface on a +X side, and cell connected bodies 10 and 20 are accommodated therein. Lid body 320 is a plate-shaped member (cover member) with a geometry corresponding to the opening in main body 310, and closes the opening on the +X side in main body 310. Main body 310 and lid body 320 may be formed of the same material or different materials. For example, metal can be adopted as the material for each of main body 310 and lid body 320. Casing 300 may be a casing made of aluminum. These materials can be changed as appropriate. For example, lid body 320 may be formed of an insulating material.

Cell connected body 10 includes four power storage cells 11 to 14 and three connection portions 2A that electrically connect the power storage cells to one another. Power storage cells 11 to 14 are connected in a line in the X direction in casing 300. Cell connected body 20 includes four power storage cells 21 to 24 and three connection portions 2B that electrically connect the power storage cells to one another. Power storage cells 21 to 24 are connected in a line in the X direction in casing 300. Cell connected body 10 and cell connected body 20 are thus arranged in parallel to the X direction. Each power storage cell is constructed to store electric power. In this embodiment, cell connected body 10, cell connected body 20, the Y direction, and the X direction correspond to an exemplary “first cell connected body,” an exemplary “second cell connected body,” an exemplary “first direction,” and an exemplary “second direction” according to the present disclosure, respectively. Power storage cells 11 to 14, power storage cells 21 to 24, connection portion 2A, and connection portion 2B correspond to an exemplary “first power storage cell,” an exemplary “second power storage cell,” an exemplary “first connection portion,” and an exemplary “second connection portion” according to the present disclosure, respectively.

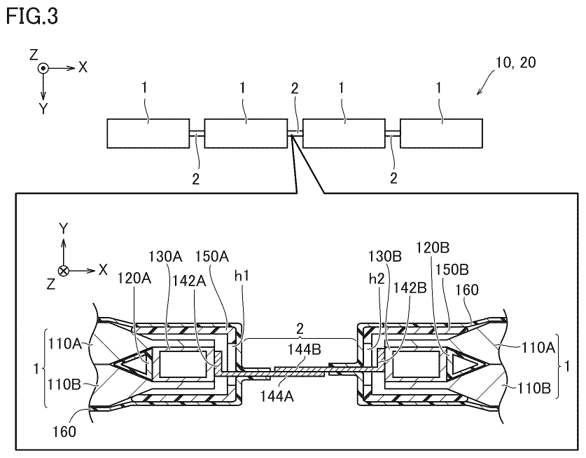

In casing 300 of battery 100, cell connected body 10 and cell connected body 20 are electrically connected to each other. Specifically, as shown in FIG. 1, an end (power storage cell 14) on the −X side of cell connected body 10 and an end (power storage cell 24) on the −X side of cell connected body 20 are electrically connected to each other, for example, through a U-shaped connection portion 2C in casing 300. Connection portion 2C has a cross-section in a U shape, whereas each of connection portions 2A and 2B has a cross-section in an I shape. Connection portion 2C is basically similar in structure to connection portion 2A or 2B except that it is formed in a different shape. Connection portion 2C may be an integrally formed article or a composite of a plurality of separately formed components. For example, connection portion 2C may be formed from connection through a conductive material (beam portion), of a protruding portion 144B (FIG. 3) that protrudes from power storage cell 14 and a protruding portion 144B (FIG. 3) that protrudes from power storage cell 24 to each other. Protruding portion 144B will be described later.

Cell connected bodies 10 and 20 are arranged such that positions of the power storage cells are aligned and positions of the connection portions are aligned. Power storage cells 11, 12, 13, and 14 included in cell connected body 10 are superimposed on power storage cells 21, 22, 23, and 24 included in cell connected body 20 in the Y direction, respectively. In other words, all power storage cells included in cell connected body 10 are arranged as being opposed in the Y direction to any power storage cells included in cell connected body 20, respectively.

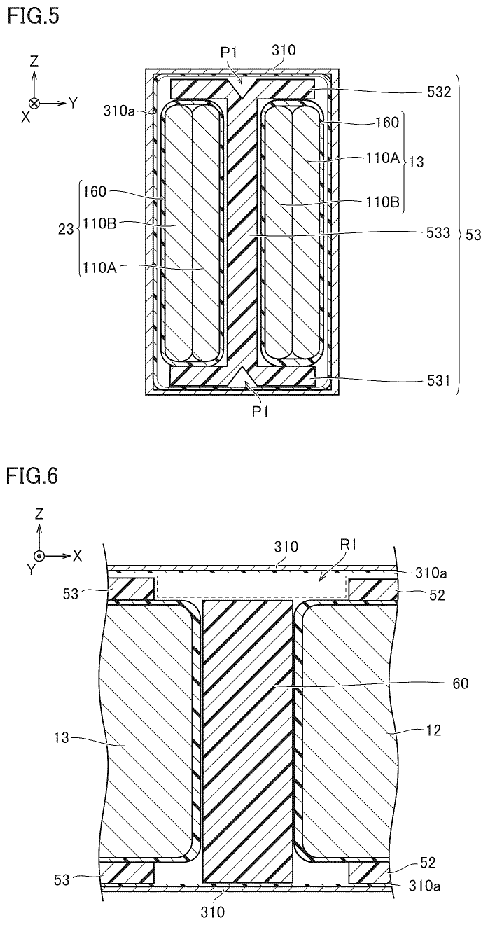

Holding members 51 to 54 are further accommodated in casing 300. Holding member 51 is arranged between power storage cells 11 and 21 opposed to each other and holds power storage cells 11 and 21. Holding member 52 is arranged between power storage cells 12 and 22 opposed to each other and holds power storage cells 12 and 22. Holding member 53 is arranged between power storage cells 13 and 23 opposed to each other and holds power storage cells 13 and 23. Holding member 54 is arranged between power storage cells 14 and 24 opposed to each other and holds power storage cells 14 and 24. Thus, in battery 100, a holding member is provided for each combination of power storage cells opposed to each other in the Y direction. According to such a construction, all power storage cells accommodated in casing 300 can be held by the holding members. Details of holding members 51 to 54 will be described later (see FIG. 5).

A plurality of spacers 60 (for example, three spacers 60) are further accommodated in casing 300. Each of the plurality of spacers 60 is superimposed on connection portions 2A and 2B in the Y direction. Specifically, each of the plurality of spacers 60 is located between connection portions 2A and 2B in the Y direction. The power storage cells adjacent in cell connected body 10 are opposed to each other in the X direction with spacer 60 lying therebetween. The power storage cells adjacent in cell connected body 20 are also opposed to each other in the X direction with spacer 60 lying therebetween. Spacer 60 is a spacer common to cell connected bodies 10 and 20 and located between power storage cells adjacent in cell connected body 10 and between power storage cells adjacent in cell connected body 20. Details of spacer 60 will be described later (see FIG. 6).

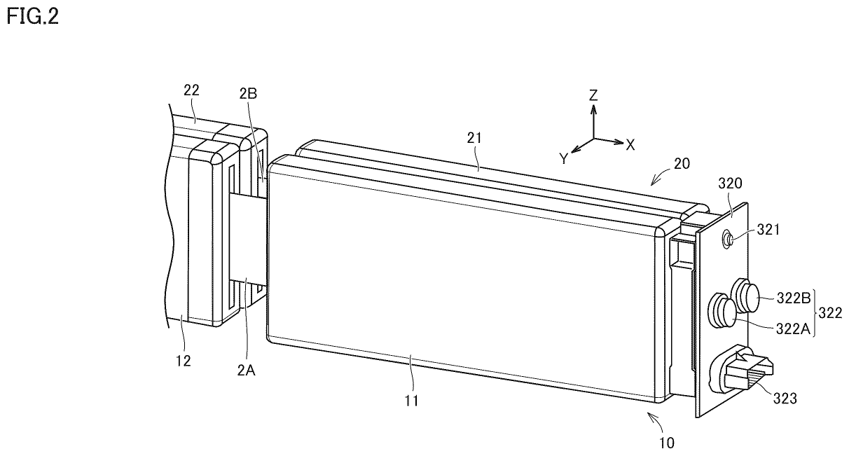

An end (power storage cell 11) on the +X side of cell connected body 10 is connected to lid body 320 with a connection terminal T1 being interposed. An end (power storage cell 21) on the +X side of cell connected body 20 is connected to lid body 320 with a connection terminal T2 being interposed. FIG. 2 is a perspective view showing as being enlarged, the ends on the +X side of cell connected bodies 10 and 20 with holding members 51 to 54 and spacers 60 having been removed.

Lid body 320 includes a sealing hole 321, an external terminal 322, and a connector 323. Sealing hole 321 may be a pressure regulation hole for regulation of a pressure in casing 300. Sealing hole 321 has a sealing structure, for example, with a metallic cap (outside of the casing) and a sealing member (inside of the casing). Such a sealing structure secures hermeticity in casing 300. External terminal 322 includes an electrode tab 322A joined (for example, welded with laser) to connection terminal T1 (FIG. 1) of cell connected body 10 and an electrode tab 322B joined (for example, welded with laser) to connection terminal T2 (FIG. 1) of cell connected body 20. Electrode tabs 322A and 322B are electrically connected to power storage cells 11 and 21, respectively. Each of electrode tabs 322A and 322B may be provided with an insulating sealing structure composed of ceramics, for example, around an electrode. In this embodiment, electrode tabs 322A and 322B function as a negative electrode tab and a positive electrode tab, respectively. Without being limited as such, with polarity being reversed, electrode tab 322B may serve as the negative electrode tab and electrode tab 322A may serve as the positive electrode tab. Connector 323 includes, for example, an output terminal that outputs a detection signal indicating a state (for example, a temperature of each power storage cell) in casing 300 detected by one or more sensors in casing 300 to the outside of the casing and an input terminal that receives input of a control signal from the outside of the casing to one or more devices in casing 300. For example, a temperature sensor may be provided for each power storage cell in casing 300.

Cell connected bodies 10 and 20 are inserted in main body 310 with holding members 51 to 54 and spacers 60 being attached thereto. As the power storage cells are held by holding members 51 to 54, insertion of cell connected bodies 10 and 20 in main body 310 is facilitated. Holding members 51 to 54 and spacers 60 may be attached before or after welding of connection portions 2A and 2B (for example, welding of protruding portions 144A and 144B which will be described later). After cell connected bodies 10 and 20 are inserted in main body 310 together with holding members 51 to 54 and spacers 60, main body 310 and lid body 320 are joined to each other. Main body 310 and lid body 320 are welded, for example, with laser.

At least one of a pressure regulation hole and a gas emission valve may be provided in an end surface on the −X side of main body 310. Similarly to the end surface on the +X side of main body 310, an opening may be provided also in the end surface on the −X side of main body 310. A lid body formed separately from hollow main body 310 may be joined to that opening (for example, welded with laser).

In this embodiment, cell connected body 10 and cell connected body 20 are basically identical to each other in construction. Therefore, when power storage cells 11 to 14 and 21 to 24 are not distinguished, they are referred to as a “power storage cell 1” below, and when connection portions 2A and 2B are not distinguished, they are referred to as a “connection portion 2” below.

FIG. 3 is a diagram for illustrating a construction of each of cell connected bodies 10 and 20. As shown in FIG. 3, each cell connected body includes four power storage cells 1. Connection portion 2 is provided between adjacent power storage cells 1 and connection portion 2 electrically connects those power storage cells 1 to each other. Each cell connected body is constructed of power storage cells 1 and connection portions 2 that are alternately aligned. In each of cell connected bodies 10 and 20, power storage cells 1 are connected to each other through connection portion 2. Connection portion 2 is lower in rigidity than power storage cell 1. Power storage cells 11 to 14 and 21 to 24 are formed from identical power storage cells 1. By forming cell connected bodies 10 and 20 from common power storage cells 1, manufacturing of battery 100 is facilitated and manufacturing cost can be reduced.

The construction of cell connected bodies 10 and 20 is not limited to the construction above. Each cell connected body may include power storage cells different in dimension or may include power storage cells different in shape. The number of power storage cells to be accommodated in casing 300 is not limited to eight but can be varied as appropriate. The number of power storage cells included in each cell connected body may be smaller than four, may be not smaller than five and not larger than nineteen, or may be equal to or larger than twenty.

In this embodiment, power storage cell 1 is a laminated cell including one or more wound bodies. In the laminated cell, one or more wound bodies that function as an electrode assembly are covered with a laminated exterior body. FIG. 2 shows the power storage cell without the laminated exterior body. The wound body has a structure, for example, in which a positive electrode sheet and a negative electrode sheet are wound with a separator lying therebetween. Each of the positive electrode sheet and the negative electrode sheet contains an electrode foil and an active material layer.

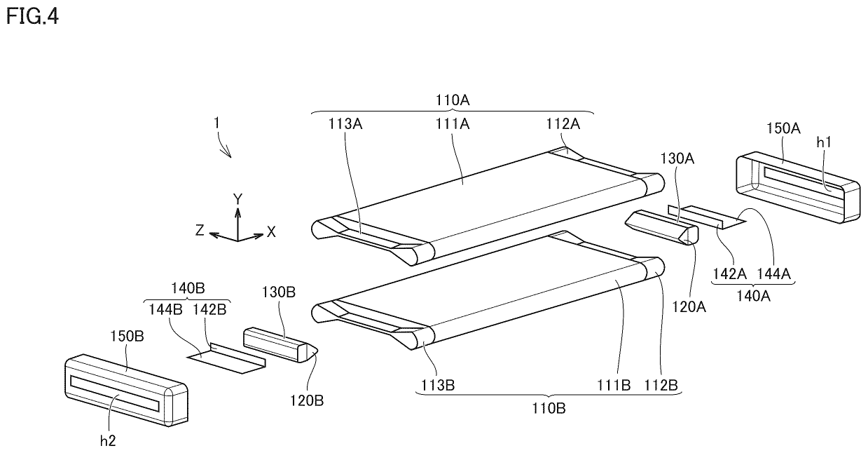

FIG. 4 is an exploded perspective view of power storage cell 1. A structure of power storage cell 1 and connection portion 2 will be described below with reference to the cross-sectional view in FIG. 3 (an X-Y cross-sectional view around connection portion 2) and FIG. 4.

As shown in FIG. 4, power storage cell 1 includes two wound bodies 110A and 110B, spacers 120A and 120B, terminal members 130A and 130B, and covers 150A and 150B.

Wound body 110A includes a coated portion 111A, an electrode tab 112A, and an electrode tab 113A. Wound body 110B includes a coated portion 111B, an electrode tab 112B, and an electrode tab 113B. Each of coated portions 111A and 111B is an area in the positive electrode sheet or the negative electrode sheet where the active material layer is provided in the electrode foil. Each of electrode tabs 112A, 112B, 113A, and 113B is an area in the positive electrode sheet or the negative electrode sheet where the electrode foil is exposed (an uncoated portion where the active material layer is not provided). Electrode tabs 112A and 112B are located at ends on the +X side of wound bodies 110A and 110B, respectively. Electrode tabs 113A and 113B are located at ends on the −X side of wound bodies 110A and 110B, respectively.

Electrode tab 112A and electrode tab 112B are arranged as being superimposed in the Y direction, and spacer 120A and terminal member 130A are provided between electrode tab 112A and electrode tab 112B (see FIG. 3). Electrode tab 113A and electrode tab 113B are arranged as being superimposed in the Y direction, and spacer 120B and terminal member 130B are provided between electrode tab 113A and electrode tab 113B (see FIG. 3).

Each of spacers 120A and 120B contains an insulating material (for example, synthetic resin) and it is insulating. Spacers 120A and 120B are each in a shape increasing in dimension in the Y direction as they are more distant from coated portions 111A and 111B (see FIG. 3). Terminal member 130A is connected to an end surface on the +X side of spacer 120A. Terminal member 130B is connected to an end surface on the −X side of spacer 120B. Each of terminal members 130A and 130B contains a conductive material (for example, metal such as aluminum or copper) and it is conductive. Wound body 110A and wound body 110B are joined to each other (for example, welded with laser) with terminal members 130A and 130B being interposed.

Each of current collection terminals 140A and 140B is a component that forms a part of connection portion 2. Current collection terminal 140A includes a support portion 142A and protruding portion 144A. Current collection terminal 140B includes a support portion 142B and protruding portion 144B. One of current collection terminals 140A and 140B functions as a positive electrode current collection terminal and the other thereof functions as a negative electrode current collection terminal. In one example, the positive electrode current collection terminal is formed of aluminum and the negative electrode current collection terminal is formed of copper.

Each of current collection terminals 140A and 140B is formed in an L shape. Each of support portions 142A and 142B is formed in a shape of a plate on a Y-Z plane and each of protruding portions 144A and 144B is formed in a shape of a plate on an X-Z plane. Support portion 142A and protruding portion 144A may be formed separately from each other and then joined to each other, or formed as being integrated by bending. Support portion 142B and protruding portion 144B may also be formed separately from each other and then joined to each other, or formed as being integrated by bending. Support portion 142A is joined (for example, welded with laser) to an end surface on the +X side of terminal member 130A (see FIG. 3). Support portion 142B is joined (for example, welded with laser) to an end surface on the −X side of terminal member 130B (see FIG. 3).

Cover 150A covers the end (including electrode tabs 112A and 112B) on the +X side of power storage cell 1. Cover 150A is provided with a through hole h1 for protruding portion 144A. Protruding portion 144A passes through through hole h1 and protrudes on the +X side of power storage cell 1 (see FIG. 3). Cover 150B covers the end (including electrode tabs 113A and 113B) on the −X side of power storage cell 1. Cover 150B is provided with a through hole h2 for protruding portion 144B. Protruding portion 144B passes through through hole h2 and protrudes on the −X side of power storage cell 1 (see FIG. 3).

As shown in FIG. 3, in connection portion 2, protruding portion 144A of one power storage cell 1 of two adjacent power storage cells 1 is joined (for example, welded with laser) to protruding portion 144B of the other power storage cell 1. A welded portion may be protected by a tape or the like. Though not shown in FIG. 4, a laminated exterior body 160 shown in FIG. 3 is provided on a surface of each of two wound bodies 110A and 110B. Laminated exterior body 160 is, for example, a laminated film and provided on a surface of power storage cell 1.

The construction described above is merely an example of the construction of power storage cell 1 and can be modified as appropriate. For example, the number of wound bodies included in power storage cell 1 is not limited to two, and a single wound body or at least three wound bodies may be provided. A layered body (for example, a layered body in which the positive electrode sheet and the negative electrode sheet are layered with the separator lying therebetween) may be adopted as the electrode assembly, instead of the wound body.

FIG. 5 is a cross-sectional view along the line V-V in FIG. 1. As shown in FIG. 5, an insulating layer 310a containing resin such as polyethylene terephthalate (PET) is provided on an inner surface of main body 310 of casing 300. Casing 300 and a component in casing 300 are thus electrically isolated from each other. In the casing (housing) where sufficient insulation is ensured, however, insulating layer 310a does not have to be provided. For example, cell connected bodies 10 and 20, holding members 51 to 54, and spacers 60 may be covered with an insulating film (insulating layer). By integrating these components with the insulating film, ease in insertion into casing 300 is improved. An end surface on the +Z side of each power storage cell may be referred to as an “upper surface” and an end surface on the −Z side of each power storage cell may be referred to as a “lower surface” below.

As shown in FIG. 5, holding member 53 has a cross-section in an X shape as a cross-section (Y-Z cross-section) orthogonal to the X direction. With such a shape, holding member 53 can clamp each of power storage cells 13 and 23 opposed to each other in the Y direction. Holding member 53 holds both of the upper surface and the lower surface of power storage cell 13 (first power storage cell) and holds both of the upper surface and the lower surface of power storage cell 23 (second power storage cell).

Specifically, holding member 53 includes a first holding portion 531, a second holding portion 532, and a main body portion 533. Main body portion 533 is located between first holding portion 531 and second holding portion 532 in the Z direction and functions as a connection portion that connects these holding portions to each other. Main body portion 533 is located between power storage cell 13 and power storage cell 23 in the Y direction and functions as a spacer that maintains an interval between these power storage cells constant. A groove P1 in the X direction is provided in each of an end surface on the −Z side of first holding portion 531 and an end surface on the +Z side of second holding portion 532. Groove P1 may function to release a pressure.

A surface on the +Z side of first holding portion 531 functions as a holding surface and is in contact with the lower surface of each of power storage cells 13 and 23. A surface on the −Z side of second holding portion 532 functions as the holding surface and is in contact with the upper surface of each of power storage cells 13 and 23. A portion on a +Y side relative to main body portion 533 of each of first holding portion 531 and second holding portion 532 corresponds to a first cell holding portion that extends from main body portion 533 toward power storage cell 13 and holds (more specifically, clamps in the Z direction) power storage cell 13. A portion on a-Y side relative to main body portion 533 of each of first holding portion 531 and second holding portion 532 corresponds to a second cell holding portion that extends from main body portion 533 toward power storage cell 23 and holds (more specifically, clamps in the Z direction) power storage cell 23.

Holding member 53 contains an insulating material (for example, resin) and it is insulating. Holding member 53 is, for example, an integrally formed article. First holding portion 531, second holding portion 532, and main body portion 533 are seamlessly integrated. Without being limited to such a structure, each portion that forms holding member 53 may separately be formed and joined. In this embodiment, each of first holding portion 531, second holding portion 532, and main body portion 533 is a resin member. Without being limited to such a form, these portions may be formed of different materials.

Though FIG. 5 representatively shows only the structure of holding member 53, other holding members (holding members 51, 52, and 54) are also similar in structure to holding member 53.

FIG. 6 is a cross-sectional view along the line VI-VI in FIG. 1. Spacer 60 shown in FIG. 6 has, for example, a geometry in a shape of a parallelepiped and is located between power storage cells 12 and 13 adjacent in cell connected body 10. Spacer 60 contains an insulating material (for example, resin) and it is insulating. A surface on the −Z side of spacer 60 is in contact with the inner surface (insulating layer 310a) of main body 310 of casing 300. A dimension in the Z direction of spacer 60 is set in correspondence with the dimension of each power storage cell. A surface on the +Z side of spacer 60 is substantially flush with the upper surface of each of power storage cells 12 and 13. A region R1 is thus provided between the surface on the +Z side of each of power storage cells 12 and 13 and spacer 60 and the inner surface (top surface) of main body 310. In region R1, at least one of a heat management system (for example, a heater and/or a temperature sensor), a gas emission system (for example, a gas flow path and/or a pressure sensor), a flexible printed circuit board (FPC), and a line connected to connector 323 may be provided. A device and/or a sensor provided in region R1 may be connected to connector 323 of lid body 320.

The dimension in the X direction of spacer 60 is set in correspondence with an interval between two adjacent power storage cells. Spacer 60 serves to set the interval between power storage cells 12 and 13 constant. Specifically, spacer 60 restricts movement of power storage cell 12 toward the −X side and movement of power storage cell 13 toward the +X side and suppresses power storage cells 12 and 13 coming too close to each other.

Though FIG. 6 representatively shows only spacer 60 located between power storage cells 12 and 13, other spacers 60 shown in FIG. 1 have the structure shown in FIG. 6. The shape of spacer 60 can be modified as appropriate. Spacer 60 may be formed, for example, into a columnar shape or a prismatic shape (a hexagonal prism, an octagonal prism, or the like) other than the shape of the parallelepiped.

Holding members 51 to 54 and spacers 60 may be fixed to casing 300 with an adhesive or a double-sided tape. By not employing the fixing method of this type, however, recyclability of the power storage device tends to be high. Battery 100 (power storage device) according to this embodiment includes the holding member that holds the first power storage cell and the second power storage cell opposed to each other, between the first power storage cell and the second power storage cell. Each of holding members 51 to 54 functions as such a holding member. According to battery 100 with such a construction, the first power storage cell and the second power storage cell are less likely to move by being held by the holding member. Therefore, an adhesive for fixing the first cell connected body and the second cell connected body does not have to be used, or adhesiveness of an adhesive to be used can be weak. Recyclability of the power storage device is thus improved. Even if cell connected bodies 10 and 20 move while they are being held by holding members 51 to 54 in casing 300, positional relation among the power storage cells is not varied and hence connection portions 2A to 2C are less likely to be damaged.

It is not essential to provide the holding members in all combinations of the power storage cells opposed to each other in the Y direction. For example, without providing holding members 52 and 53 among holding members 51 to 54, holding members 51 and 54 may hold only opposing ends in the X direction of cell connected bodies 10 and 20. Alternatively, without providing holding members 51 and 54 among holding members 51 to 54, holding members 52 and 53 may hold only central portions in the X direction of cell connected bodies 10 and 20.

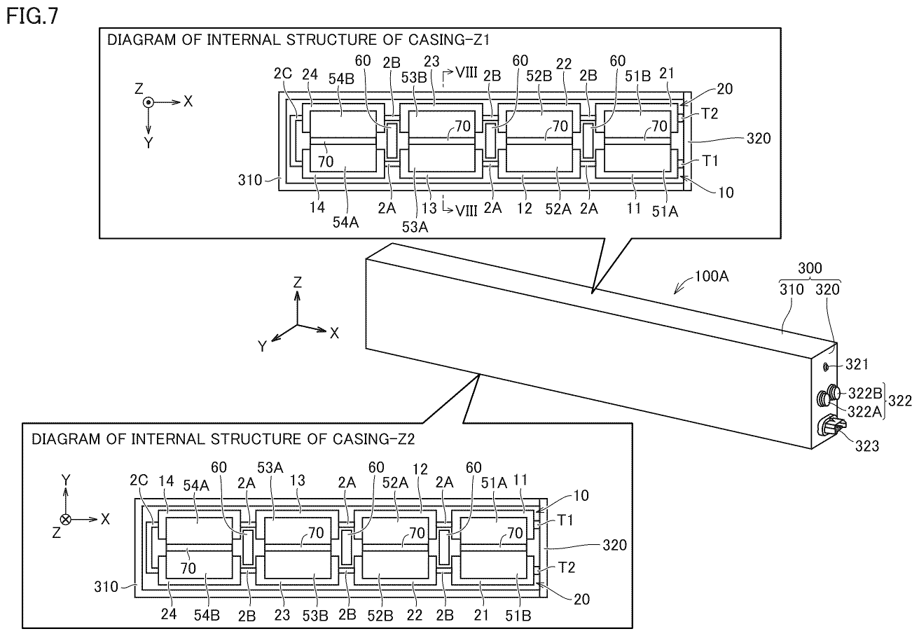

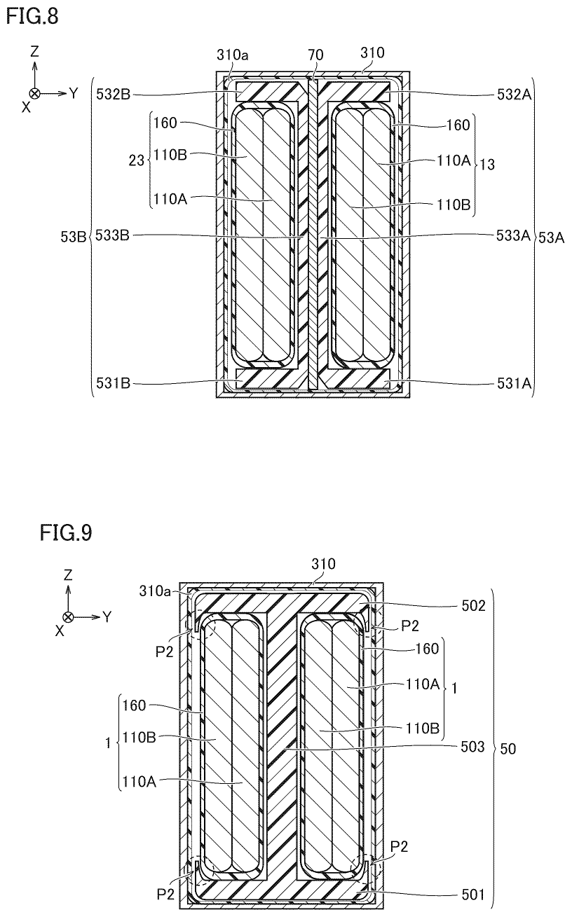

FIG. 7 is a diagram showing a first modification of the battery shown in FIG. 1. FIG. 8 is a cross-sectional view along the line VIII-VIII in FIG. 7.

As shown in FIG. 7, a battery 100A according to the first modification is basically similar in construction to battery 100 shown in FIG. 1. In battery 100A, resin members 51A and 51B and a metallic plate 70 instead of holding member 51 (FIG. 1) are adopted, resin members 52A and 52B and metallic plate 70 instead of holding member 52 (FIG. 1) are adopted, resin members 53A and 53B and metallic plate 70 instead of holding member 53 (FIG. 1) are adopted, and resin members 54A and 54B and metallic plate 70 instead of holding member 54 (FIG. 1) are adopted.

As shown in FIG. 8, resin member 53A has a cross-section in a C shape as the cross-section (Y-Z cross-section) orthogonal to the X direction. Resin member 53A can clamp power storage cell 13 owing to such a shape. Specifically, resin member 53A includes a first holding portion 531A, a second holding portion 532A, and a main body portion 533A. A portion (corner portion) where each of first holding portion 531A and second holding portion 532A is connected to main body portion 533A may be beveled. Main body portion 533A is located between first holding portion 531A and second holding portion 532A in the Z direction and functions as the connection portion that connects these holding portions to each other. Main body portion 533A is located between power storage cell 13 and power storage cell 23 in the Y direction. First holding portion 531A and second holding portion 532A correspond to the first cell holding portion that extends from main body portion 533A toward power storage cell 13 and holds (more specifically, clamps) power storage cell 13. Resin member 53A holds both of the upper surface and the lower surface of power storage cell 13 (first power storage cell).

Resin member 53B has a cross-section in a C shape in an orientation opposite to resin member 53A, as the cross-section (Y-Z cross-section) orthogonal to the X direction. Resin member 53B can clamp power storage cell 23 owing to such a shape. Specifically, resin member 53B includes a first holding portion 531B, a second holding portion 532B, and a main body portion 533B. A portion (corner portion) where each of first holding portion 531B and second holding portion 532B is connected to main body portion 533B may be beveled. Main body portion 533B is located between first holding portion 531B and second holding portion 532B in the Z direction and functions as the connection portion that connects these holding portions to each other. Main body portion 533B is located between power storage cell 13 and power storage cell 23 in the Y direction. First holding portion 531B and second holding portion 532B correspond to the second cell holding portion that extends from main body portion 533B toward power storage cell 23 and holds (more specifically, clamps) power storage cell 23. Resin member 53B holds both of the upper surface and the lower surface of power storage cell 23 (second power storage cell).

Each of resin members 53A and 53B is formed of resin. Metallic plate 70 is located between resin member 53A and resin member 53B in the Y direction. Opposing ends in the Z direction of metallic plate 70 are in contact with the inner surface of main body 310 of casing 300. Metallic plate 70 is, for example, an aluminum plate. Without being limited as such, metallic plate 70 may be formed of metal other than aluminum. Metallic plate 70 may be, for example, a copper plate or a stainless steel plate.

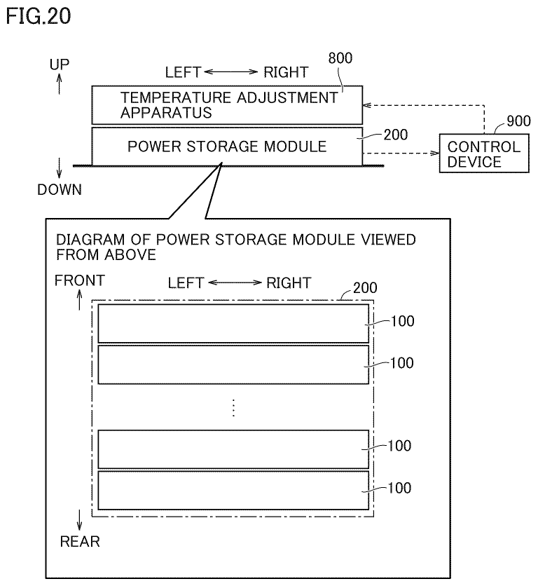

Metallic plate 70 is joined (for example, welded) to each of resin members 53A and 53B, and resin members 53A and 53B and metallic plate 70 function as the holding member that holds power storage cells 13 and 23 opposed to each other in the Y direction. While such a holding member appropriately holds the power storage cells with resin members 53A and 53B, it can achieve enhanced thermal conductivity between the power storage cells and the surroundings thereof owing to metallic plate 70. For example, heat from each power storage cell tends to be radiated to the outside (for example, a temperature adjustment apparatus 800 shown in FIG. 20 which will be described later) of casing 300 through metallic plate 70. In heating of each power storage cell from the outside (for example, temperature adjustment apparatus 800 shown in FIG. 20 which will be described later) of casing 300, heat more readily conducts to each power storage cell through metallic plate 70. As metallic plate 70 is in contact with casing 300, thermal conductivity between each power storage cell and casing 300 is enhanced. In a form where sufficient thermal conductivity is ensured without such a construction, however, at least one end in the Z direction of metallic plate 70 does not have to be in contact with casing 300.

Though FIG. 8 representatively shows only the holding member (resin members 53A and 53B and metallic plate 70) located between power storage cells 13 and 23, the holding member (resin members 51A and 51B and metallic plate 70) located between power storage cells 11 and 21, the holding member (resin members 52A and 52B and metallic plate 70) located between power storage cells 12 and 22, and the holding member (resin members 54A and 54B and metallic plate 70) located between power storage cells 14 and 24 also have the structure shown in FIG. 8.

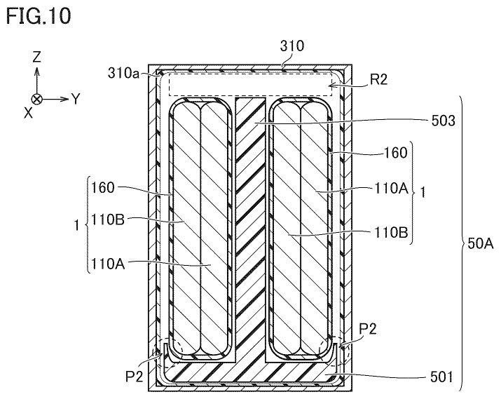

FIG. 9 is a diagram showing a modification of the structure of the holding member shown in FIG. 5. Holding member 50 shown in FIG. 9 includes a first holding portion 501, a second holding portion 502, and a main body portion 503. First holding portion 501, second holding portion 502, and main body portion 503 are basically similar in construction to first holding portion 531, second holding portion 532, and main body portion 533 shown in FIG. 5, respectively. A tab portion P2 is provided at each of opposing ends in the Y direction of each of first holding portion 501 and second holding portion 502.

A portion (first cell holding portion) on the +Y side relative to main body portion 503 of each of first holding portion 501 and second holding portion 502 holds power storage cell 1 (first power storage cell) with the holding surface and tab portion P2. Such a first cell holding portion clamps the first power storage cell in the Z direction with the holding surface and suppresses movement of the first power storage cell to the outside (+Y side) with tab portion P2. Tab portion P2 of the first cell holding portion catches the first power storage cell and serves to maintain the first power storage cell at a prescribed position.

A portion (second cell holding portion) on the −Y side relative to main body portion 503 of each of first holding portion 501 and second holding portion 502 holds power storage cell 1 (second power storage cell) with the holding surface and tab portion P2. Such a second cell holding portion clamps the second power storage cell in the Z direction with the holding surface and suppresses movement of the second power storage cell to the outside (−Y side) with tab portion P2. Tab portion P2 of the second cell holding portion catches the second power storage cell and serves to maintain the second power storage cell at a prescribed position.

For example, in battery 100, holding member 50 constructed described above may be adopted instead of at least one of holding members 51 to 54. A groove (groove P1 shown in FIG. 5) is not provided in each of first holding portion 501 and second holding portion 502 shown in FIG. 9. Without being limited as such, groove P1 may be provided in each of first holding portion 501 and second holding portion 502.

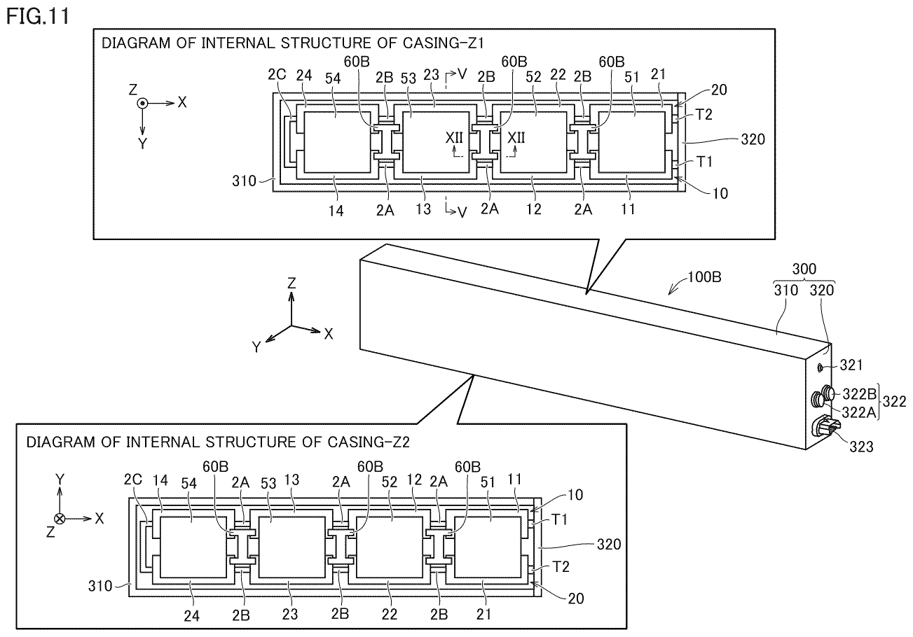

FIG. 10 is a diagram showing a modification of the holding member shown in FIG. 9. A holding member 50A shown in FIG. 10 has such a structure that second holding portion 502 has been removed from holding member 50 shown in FIG. 9. Holding member 50A has a cross-section in a T shape as the cross-section (Y-Z cross-section) orthogonal to the X direction. In holding member 50A, a portion (first cell holding portion) on the +Y side relative to main body portion 503 of first holding portion 501 holds power storage cell 1 (first power storage cell) with the holding surface and tab portion P2. A portion (second cell holding portion) on the −Y side relative to main body portion 503 of first holding portion 501 holds power storage cell 1 (second power storage cell) with the holding surface and tab portion P2. A space (a region R2) is provided between the inner surface (top surface) of main body 310 of casing 300 and the surface on the +Z side of each of two adjacent power storage cells 1 and main body portion 503 located therebetween. At least one of the heat management system, the gas emission system, the FPC, and the line connected to connector 323 may be provided in region R2.

For example, in battery 100, holding member 50A constructed described above may be adopted instead of at least one of holding members 51 to 54.

In battery 100 shown in FIG. 1, spacer 60 common to the first cell connected body and the second cell connected body is adopted. Without being limited as such, a spacer may separately be provided between adjacent power storage cells, in each of the first cell connected body and the second cell connected body. Spacer 60 may be replaced with the holding member.

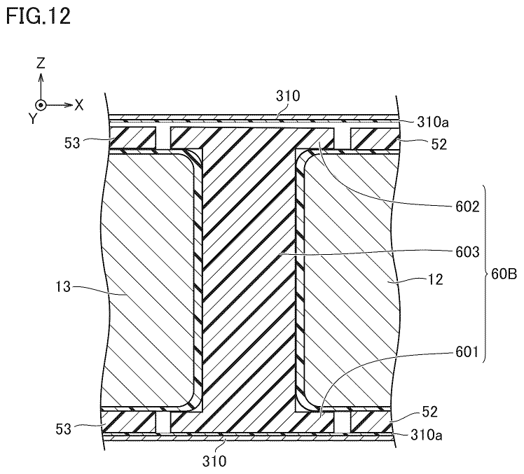

FIG. 11 is a diagram showing a second modification of the battery shown in FIG. 1. FIG. 12 is a cross-sectional view along the line XII-XII in FIG. 11.

As shown in FIGS. 11 and 12, a battery 100B according to the second modification is basically similar in construction to battery 100 shown in FIG. 1. In battery 100B, three holding members 60B instead of three spacers 60 (FIG. 1) are adopted. The cross-section along the line V-V in FIG. 11 is the same as the cross-section shown in FIG. 5.

As shown in FIG. 11, holding member 60B is formed in an H shape in the plane (X-Y plane) orthogonal to the Z direction. As shown in FIG. 12, holding member 60B has a cross-section in an X shape as the cross-section (X-Z cross-section) orthogonal to the Y direction. With such a shape, holding member 60B can clamp each of power storage cells 12 and 13 opposed to each other in the X direction. Holding member 60B holds both of the upper surface and the lower surface of power storage cell 12 and both of the upper surface and the lower surface of power storage cell 13.

Specifically, holding member 60B includes a first holding portion 601, a second holding portion 602, and a main body portion 603. Main body portion 603 is located between first holding portion 601 and second holding portion 602 in the Z direction and functions as the connection portion that connects these holding portions to each other. Main body portion 603 is located between power storage cell 12 and power storage cell 13 in the X direction, and functions as the spacer that maintains the interval between these power storage cells constant. A groove in the Y direction may be provided in at least one of an end surface on the −Z side of first holding portion 601 and an end surface on the +Z side of second holding portion 602.

A surface on the +Z side of first holding portion 601 functions as the holding surface and is in contact with the lower surface of each of power storage cells 12 and 13. A surface on the −Z side of second holding portion 602 functions as the holding surface and is in contact with the upper surface of each of power storage cells 12 and 13. A portion on the +X side relative to main body portion 603 of each of first holding portion 601 and second holding portion 602 extends from main body portion 603 toward power storage cell 12 and holds (more specifically, clamps) power storage cell 12. A portion on the −X side relative to main body portion 603 of each of first holding portion 601 and second holding portion 602 extends from main body portion 603 toward power storage cell 13 and holds (more specifically, clamps) power storage cell 13.

Holding member 60B contains an insulating material (for example, resin) and it is insulating. Holding member 60B is, for example, an integrally formed article. First holding portion 601, second holding portion 602, and main body portion 603 are seamlessly integrated. Without being limited to such a structure, each portion that forms holding member 60B may separately be formed and joined. Each of first holding portion 601, second holding portion 602, and main body portion 603 is, for example, a resin member. Without being limited as such, these portions may be formed of different materials.

Though FIG. 12 representatively shows only holding member 60B located between power storage cells 12 and 13, other holding members 60B shown in FIG. 11 have the structure shown in FIG. 12. According to holding member 60B, movement of cell connected bodies 10 and 20 is more readily suppressed.

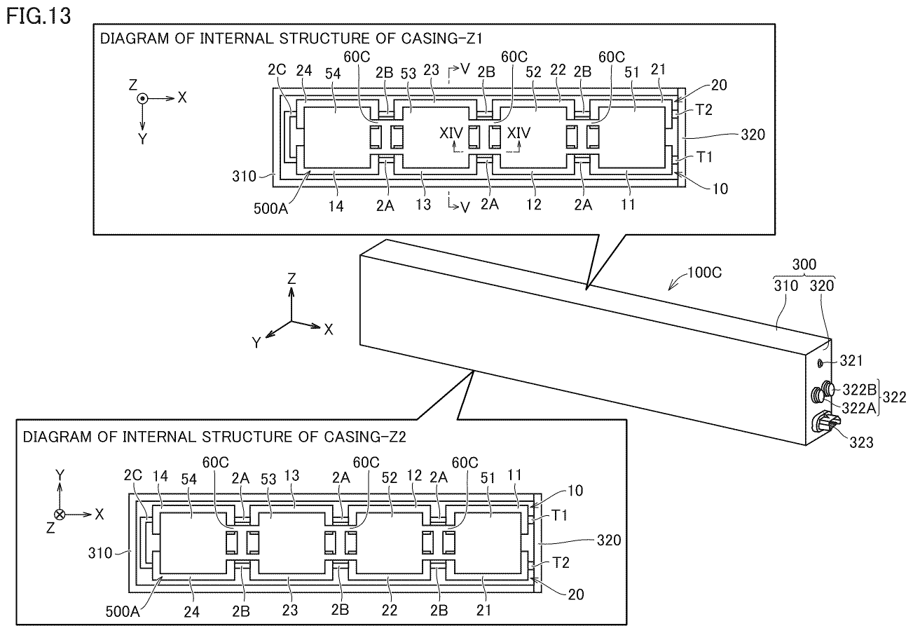

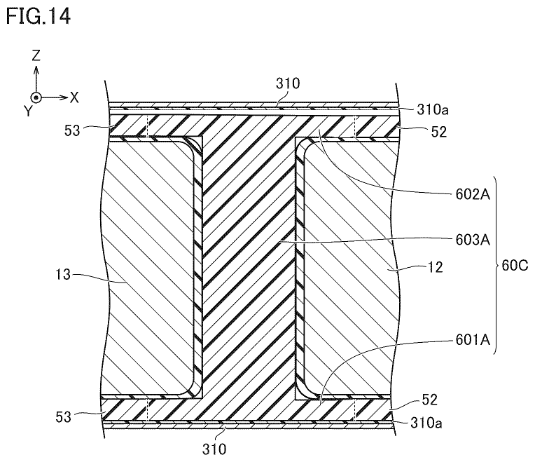

FIG. 13 is a diagram showing a third modification of the battery shown in FIG. 1. FIG. 14 is a cross-sectional view along the line XIV-XIV in FIG. 13.

As shown in FIGS. 13 and 14, a battery 100C according to the third modification is basically similar in construction to battery 100B shown in FIG. 11. In battery 100C, a holding member 60C instead of holding member 60B (FIGS. 11 and 12) is adopted. The cross-section along the line V-V in FIG. 13 is the same as the cross-section shown in FIG. 5.

As shown in FIG. 13, in battery 100C, holding members 51 to 54 and holding members 60C arranged between adjacent holding members to connect these holding members 51 to 54 to one another form a single holding member 500A. Holding member 500A includes holding members 51 to 54 and holding members 60C formed to physically connect the holding members to one another. Holding members 51 to 54 are connected in a line in the X direction in casing 300. Holding member 60C is provided at three locations. Holding member 60C located between holding members 51 and 52 in the X direction functions as the connection portion that connects holding members 51 and 52 to each other. Holding member 60C located between holding members 52 and 53 in the X direction functions as the connection portion that connects holding members 52 and 53 to each other. Holding member 60C located between holding members 53 and 54 in the X direction functions as the connection portion that connects holding members 53 and 54 to each other.

As shown in FIG. 14, holding member 60C is basically similar in construction to holding member 60B shown in FIG. 12. Holding member 60C includes a first holding portion 601A, a second holding portion 602A, and a main body portion 603A. First holding portion 601A, second holding portion 602A, and main body portion 603A are basically similar in construction to first holding portion 601, second holding portion 602, and main body portion 603 shown in FIG. 12, respectively. First holding portion 601A is connected to holding members 52 and 53 adjacent thereto on the +X side and the −X side. Second holding portion 602A is also connected to holding members 52 and 53 adjacent thereto on the +X side and the −X side.

Though FIG. 14 representatively shows only holding member 60C located between power storage cells 12 and 13, other holding members 60C shown in FIG. 13 also have the structure shown in FIG. 14. According to holding member 500A, movement of cell connected bodies 10 and 20 is more readily suppressed. Holding member 500A may be an integrally formed article or such a composite that a plurality of separately formed members are joined to one another.

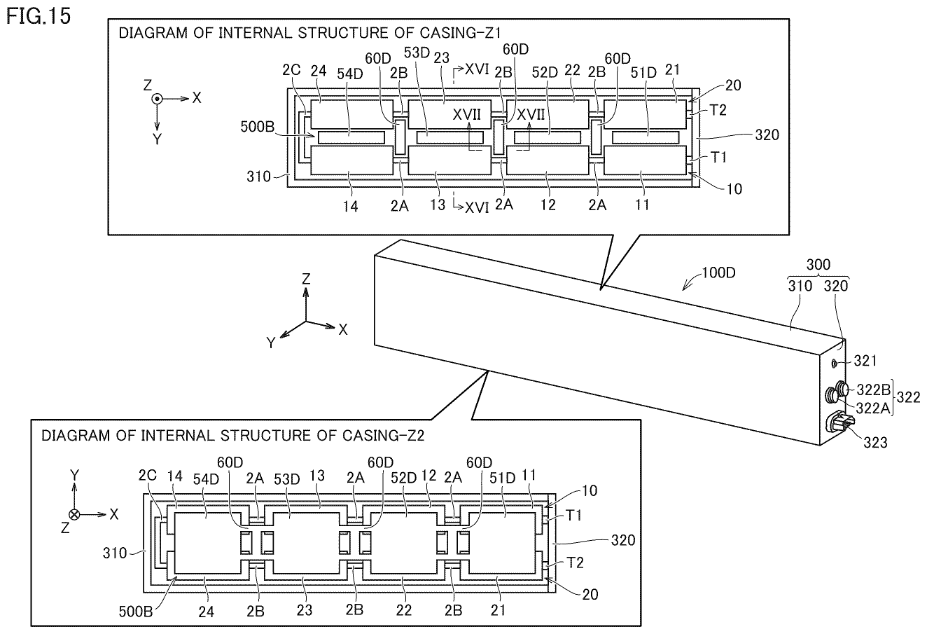

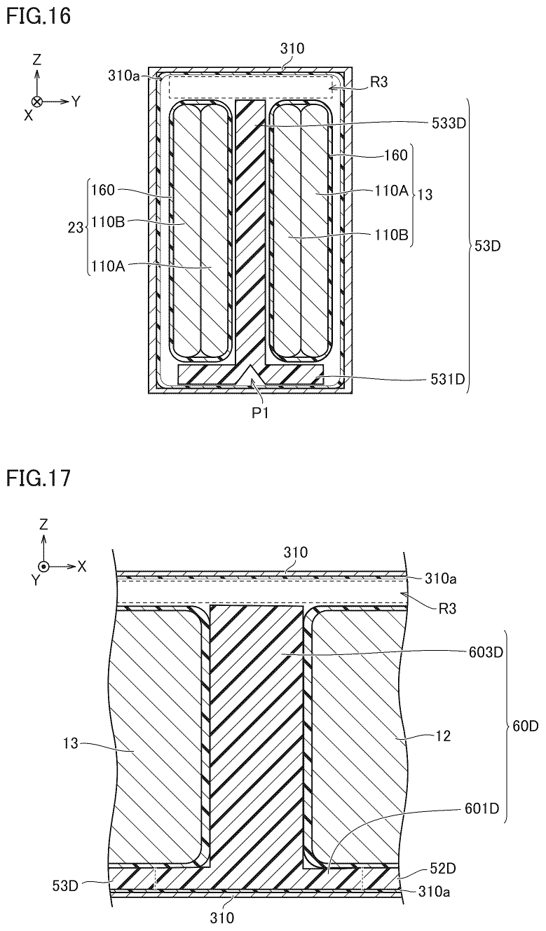

FIG. 15 is a diagram showing a fourth modification of the battery shown in FIG. 1. FIG. 16 is a cross-sectional view along the line XVI-XVI in FIG. 15. FIG. 17 is a cross-sectional view along the line XVII-XVII in FIG. 15.

As shown in FIGS. 15 to 17, a battery 100D according to the fourth modification is basically similar in construction to battery 100C shown in FIG. 13. In battery 100D, a holding member 500B instead of holding member 500A (FIG. 13) is adopted.

Holding member 500B includes holding members 51D, 52D, 53D, and 54D and holding members 60D provided between adjacent holding members to connect these holding members 51D to 54D to one another. In holding member 500B, an end on the −Z side of each of holding members 51D to 54D is connected in the X direction with holding member 60D being interposed. Holding member 60D is provided at three locations.

As shown in FIG. 16, holding member 53D has such a structure that second holding portion 532 has been removed from holding member 53 shown in FIG. 5. Holding member 53D includes a first holding portion 531D and a main body portion 533D similar in structure to first holding portion 531 and main body portion 533 shown in FIG. 5, respectively. Though FIG. 16 representatively shows only holding member 53D, each of holding members 51D, 52D, and 54D has the structure shown in FIG. 16.

As shown in FIG. 17, holding member 60D has such a structure that second holding portion 602A has been removed from holding member 60C shown in FIG. 14. Holding member 60D includes a first holding portion 601D and a main body portion 603D similar in structure to first holding portion 601A and main body portion 603A shown in FIG. 14, respectively. Though FIG. 17 representatively shows only holding member 60D located between power storage cells 12 and 13, other holding members 60D shown in FIG. 15 have the structure shown in FIG. 17.

As shown in FIGS. 16 and 17, in battery 100D, a space (a region R3) is provided between the inner surface (top surface) of main body 310 of casing 300 and the surface on the +Z side of each of the plurality of power storage cells and the plurality of holding members described above. In region R3, at least one of the heat management system, the gas emission system, the FPC, and the line connected to connector 323 may be provided. According to holding member 500B, a space is more readily secured in casing 300. Holding member 500B may be an integrally formed article or such a composite that a plurality of separately formed members are joined to one another.

A flow path through which smoke emitted from a power storage cell may be provided in spacer 60, holding member 60B, holding member 60C, or holding member 60D described previously. FIG. 18 is a diagram showing an example in which the flow path is provided in spacer 60 shown in FIG. 6. In the example shown in FIG. 18, a flexible printed circuit board (FPC) 700 is provided in region R1 shown in FIG. 6 and a flow path GL1 is provided in spacer 60. A spacer 60E shown in FIG. 18 is obtained by providing flow path GL1 in spacer 60. Spacer 60E is located between the power storage cells adjacent in cell connected body 10 (first cell connected body) and between the power storage cells adjacent in cell connected body 20 (second cell connected body), similarly to spacer 60 shown in FIG. 1. FPC 700 is constructed to sense smoke. FPC 700 may be constructed to be disconnected, for example, when smoke is emitted. Spacer 60E is provided with flow path GL1 that guides smoke emitted from each of adjacent power storage cells 12 and 13 to FPC 700. When FPC 700 senses smoke emitted from at least one of adjacent power storage cells 12 and 13, it may output a signal indicating that fact to connector 323.

In battery 100 shown in FIG. 1, flow path GL1 may be provided in all of three spacers 60 or only in one spacer 60 or two spacers 60. Flow path GL1 shown in FIG. 18 may be modified to guide smoke from any one of adjacent power storage cells 12 and 13 to FPC 700.

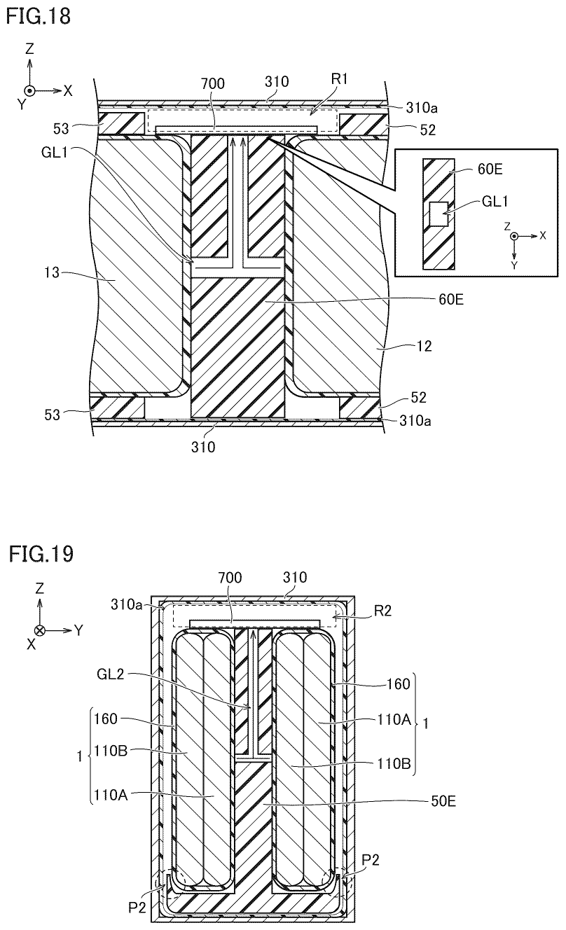

The flow path through which smoke emitted from the power storage cell flows may be provided in holding members 51 to 54, holding member 50, holding member 50A, resin members 51A to 54A, resin members 51B to 54B, or holding members 51D to 54D described previously. FIG. 19 is a diagram showing an example in which the flow path is provided in holding member 50A shown in FIG. 10. In the example shown in FIG. 19, FPC 700 is provided in region R2 shown in FIG. 10 and a flow path GL2 is provided in holding member 50A. A holding member 50E shown in FIG. 19 is obtained by providing flow path GL2 in holding member 50A. Holding member 50E is adopted instead of at least one of holding members 51 to 54 shown in FIG. 1 and it holds the first power storage cell and the second power storage cell opposed to each other in the Y direction, between the first power storage cell and the second power storage cell. FPC 700 is constructed to sense smoke. Holding member 50E is provided with flow path GL2 that guides to FPC 700, smoke emitted from each of two power storage cells 1 (the first power storage cell and the second power storage cell) opposed to each other in the Y direction. When FPC 700 senses smoke emitted from at least one of two power storage cells 1 opposed to each other, it may output a signal indicating that fact to connector 323. Flow path GL2 shown in FIG. 19 may be modified to guide smoke from any one of two power storage cells 1 opposed to each other in the Y direction to FPC 700.

Batteries 100 and 100A to 100D and a modified embodiment thereof described previously alone can function as the power storage device. A plurality of such batteries may be combined into a module.

FIG. 20 is a diagram showing an exemplary power storage module including a plurality of batteries. FIG. 20 shows an upward-downward direction, a forward-rearward direction, and a left-right direction orthogonal to one another. “Down” corresponds to a vertical direction (a direction of gravity) and “up” refers to a direction opposite thereto. A figure showing the power storage module viewed from above shows an internal structure of a power storage module 200.

Power storage module 200 shown in FIG. 20 includes a plurality of batteries 100. In power storage module 200, the plurality of batteries 100 (see FIG. 1) are arranged such that a surface on the +Z side of each battery faces up and a surface on the −Z side of each battery faces down. For each of the plurality of batteries 100, which of the left and the right lid body 320 (the surface on the +X side) shown in FIGS. 1 and 2 should face can freely be set. For example, orientations of all batteries 100 may be aligned in power storage module 200. Alternatively, power storage module 200 may include both of battery 100 lid body 320 of which faces the right and battery 100 lid body 320 of which faces the left. The plurality of batteries 100 may be connected electrically in series or in parallel. Power storage module 200 functions as the power storage device.

In the example shown in FIG. 20, temperature adjustment apparatus 800 is provided on an upper surface of power storage module 200. Temperature adjustment apparatus 800 is configured to adjust a temperature of each of the plurality of batteries 100 included in power storage module 200. Temperature adjustment apparatus 800 may include at least one of a heater and a cooler. Temperature adjustment apparatus 800 is controlled by a control device 900. Control device 900 includes, for example, a processor and a storage device, and it is connected through a signal line to connector 323 (FIG. 1) of each of the plurality of batteries 100 included in power storage module 200. Control device 900 receives a signal (for example, a sensor detection value) from connector 323 of each battery and sends a control command to temperature adjustment apparatus 800. Control device 900 may control temperature adjustment apparatus 800 based on a state of each battery. In power storage module 200, another battery (any of batteries 100A to 100D or a battery obtained by making various modifications described previously to the construction thereof) may be adopted instead of battery 100. Temperature adjustment apparatus 800 may be provided on a lower surface of power storage module 200.

Batteries 100 and 100A to 100D and the modified embodiment thereof described previously and power storage module 200 may be mounted, for example, on a mobile body. Examples of the mobile body include a car (an electric car, a hybrid vehicle, or the like), a vehicle other than the car (a ship, an airplane, or the like), a mobile machine (an agricultural machine, a construction machine, or the like), and an unmanned mobile body (an automated guided vehicle, a robot, or the like). Any application of the power storage device may be applicable, and the power storage device may be for a stationary use.

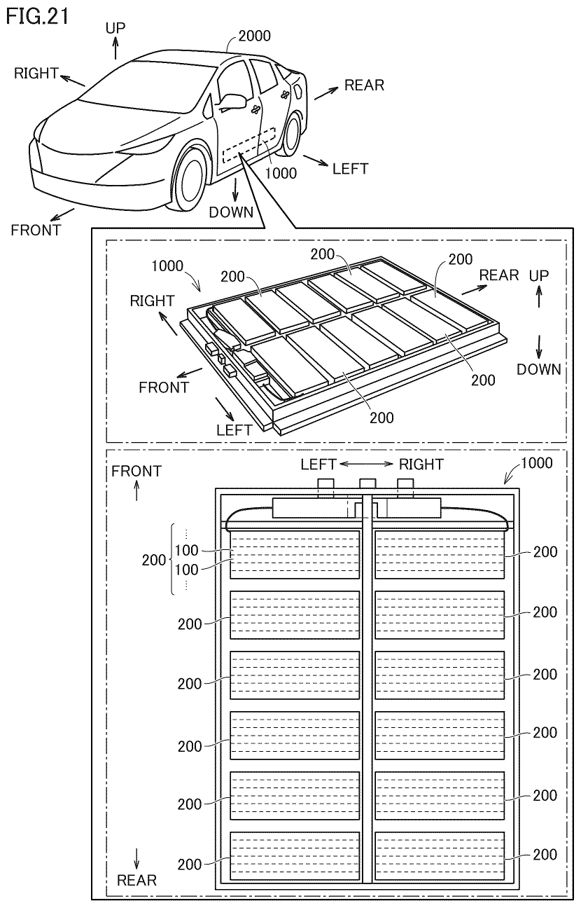

FIG. 21 is a diagram showing an exemplary vehicle on which the power storage module shown in FIG. 20 is mounted. A vehicle 2000 shown in FIG. 21 includes a battery pack 1000. Battery pack 1000 includes a plurality of power storage modules 200 and functions as the power storage device. Battery pack 1000 may further include temperature adjustment apparatus 800 shown in FIG. 20. Battery pack 1000 may be placed on or below a floor of vehicle 2000. Vehicle 2000 is an electric vehicle configured to travel with electric power outputted, for example, from battery pack 1000. Battery pack 1000 may supply electric power to a travel motor mounted on vehicle 2000. In battery pack 1000, power storage modules 200 are electrically connected to one another, for example, through a bus bar. Battery pack 1000 may include at least one hundred power storage cells.

Various characteristics (characteristics described in the embodiment and the modifications) in connection with the power storage devices described above may freely be combined and carried out. The power storage device may be applied to an apparatus other than the vehicle.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a first cell coupled body and a second cell coupled body electrically connected to each other,
the first cell coupled body including a plurality of first power storage cells and a first connection portion that electrically connects the first power storage cells to each other,
the second cell coupled body including a plurality of second power storage cells and a second connection portion that electrically connects the second power storage cells to each other,
at least one of the plurality of first power storage cells being arranged as being opposed in a first direction to any of the plurality of second power storage cells; and
a holding member that holds the first power storage cell and the second power storage cell that are opposed to each other, at least a portion of the holding member being located between the first power storage cell and the second power storage cell that are opposed to each other.

2. The power storage device according to claim 1, wherein
the holding member includes
a main body portion located between the first power storage cell and the second power storage cell,
a first cell holding portion that extends from the main body portion toward the first power storage cell and holds the first power storage cell, and
a second cell holding portion that extends from the main body portion toward the second power storage cell and holds the second power storage cell.

3. The power storage device according to claim 2, wherein
the main body portion is located between the first power storage cell and the second power storage cell in the first direction,
the first cell holding portion clamps the first power storage cell, and
the second cell holding portion clamps the second power storage cell.

4. The power storage device according to claim 1, wherein
the plurality of first power storage cells in the first cell coupled body are aligned in a second direction orthogonal to the first direction,
the plurality of second power storage cells in the second cell coupled body are aligned in the second direction, and
the holding member has a cross-section in an X shape as a cross-section orthogonal to the second direction.

5. The power storage device according to claim 1, wherein
the holding member includes
a first resin member that holds the first power storage cell,
a second resin member that holds the second power storage cell, and
a metallic plate located between the first resin member and the second resin member.

6. The power storage device according to claim 1, further comprising a circuit board that senses smoke, wherein
the holding member is provided with a flow path that guides smoke emitted from at least one of the first power storage cell and the second power storage cell opposed to each other to the circuit board.

7. The power storage device according to claim 1, further comprising:
a circuit board that senses smoke; and
a spacer located between power storage cells adjacent in the first cell coupled body and/or between power storage cells adjacent in the second cell coupled body, wherein
the spacer is provided with a flow path that guides smoke emitted from at least one of the adjacent power storage cells to the circuit board.

8. The power storage device according to claim 1, wherein
each of the plurality of first power storage cells is arranged as being opposed in the first direction to any of the plurality of second power storage cells, and
the holding member is provided for each combination of the first power storage cell and the second power storage cell opposed to each other.

9. A vehicle comprising the power storage device according to claim 1.
